(19) United States
(12) Patent Application Publication
(10) Pub. No.: US 2020/0401930 A1
(43) Pub. Date: Dec. 24, 2020

(54) DESIGN OF CUSTOMIZABLE MACHINE LEARNING SERVICES

(71) Applicant: SAP SE, Walldorf (DE)

(72) Inventors: Sergey SMIRNOV, Heidelberg (DE); Francesco ALDA, Wiesloch (DE); Evgeny ARNAUTOV, Stutensee (DE); Michael HAAS, Mannheim (DE); Amrit RAJ, Leimen (DE); Ekaterina SUTTER, Wiesloch-Schatthausen (DE)

(21) Appl. No.: 16/445,807

(22) Filed: Jun. 19, 2019

(51) Int. Cl. G06N 20/00

(52) U.S. Cl. CPC G06N 20/00

(57) ABSTRACT

Disclosed herein are system, method, and computer program product embodiments for classifying a new record. An embodiment operates by receiving a dataset unique to a user, wherein the dataset includes a plurality of records separate from the new record, and receiving a dataset schema. Thereafter, the dataset is validated based on the dataset schema. Subsequently, a request for creating a machine learning model based on a selected model template and dataset is received. After creating the custom machine learning model, a request for classifying the new record based on the created machine learning model is received. Upon determining the classification of the new record based on the custom machine learning model, the classification for the new record is outputted to the user.

### BACKGROUND

Machine learning models have historically been deployed to assist users in identifying patterns in their data. However, current machine learning models focus on providing such a capability to a wide variety of use cases and/or different types of users. Such generic machine learning models provide users having user-specific data and/or domains with poor performance. Additionally, generic machine learning models may not provide users with an indication of whether or not the training data is sufficient to obtain accurate results. Accordingly, it is typically unbeknownst to users if the results are reliable or accurate.

### BRIEF DESCRIPTION OF THE DRAWINGS

The accompanying drawings are incorporated herein and form a part of the specification.

FIG. 1 is a block diagram of a system for classification of a new record based on a custom machine learning model, according to some embodiments.

FIG. 2 is an example server, according to some embodiments.

FIG. 3 is an example method for classifying a new record based on a custom machine learning model, according to some embodiments.

FIG. 4 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for classifying a new record based on a custom machine learning model. The new record may be any type of service or product to a user. As such, the record may be well-known or new to the public. For example, the record may be a well-known product/service type (e.g., a t-shirt) or an unknown product/service type (e.g., a new type of device).

In some embodiments, a user may provide a dataset of existing records and a dataset schema, which either or both may be unique to the user. The dataset may be validated based on the dataset schema. Thereafter, the user may select a model template, which may be generic or unique to the user. Based on the model template and the dataset, a custom machine learning model may be created to determine an appropriate classification for the new record. In an example embodiment, the classification may be for a new or existing record. By operating in such a fashion, the custom machine learning model will be unique to the user and provide an accurate classification of the record. The types of classifications may include a multi-class classification and/or multi-label hierarchical classification. As such, the classes to be predicted may be organized into a hierarchy, such as a tree or a Directed Acyclic Graph (DAG). And the hiercarchy may be specified by users.

For example, where a user will be launching new products, the user may provide a product portfolio of existing products and their classification. The user may then select a model template. Based on the provided product portfolio and selected model template, a custom machine learning model is created that is unique to the user. And the custom machine learning model may determine the appropriate classification for the new products.

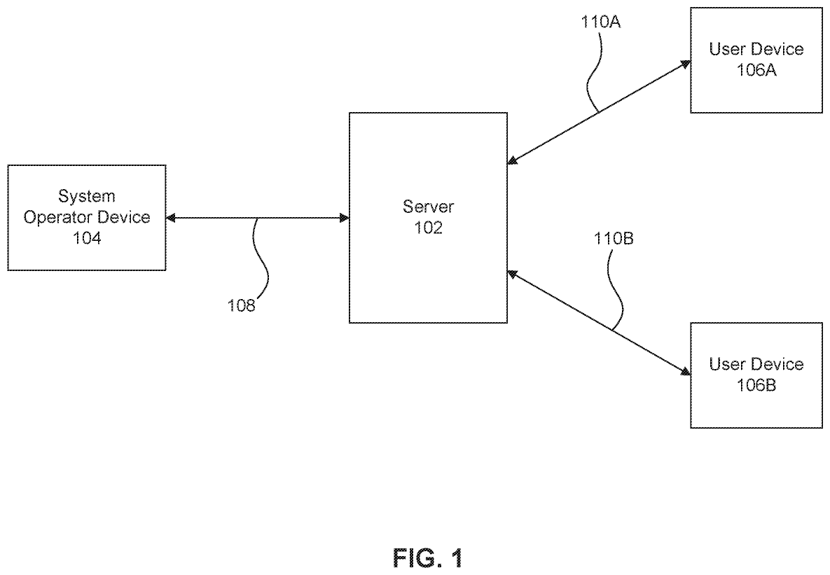

FIG. 1 is an example system 100 for classifying a new record based on a custom machine learning model. The system 100 includes a server 102, an operator device 104, and/or user devices 106. The server 102 and the operator device 104 may be managed by the same entity (e.g., an organization). The user devices 106 may be personal user devices and/or business user devices. Along these lines, the server 102 may be in communication with the operator device 104 over a first communication line or medium 108 and may be in communication with the user devices 106 over a second communication line or medium 110. Since the server 102 and the operator device 104 may be managed by the same entity, the first communication line or medium 108 may be private. In some embodiments, the second communication line or medium 110 may be private or public. For example, where the user devices 106 are personal user devices, the second communication line or medium 110 may be public. And where the user devices 106 are business user devices, the second communication line or medium 110 may be private.

As will be discussed in more detail below, the server 102 may be configured to generate a custom machine learning model and classify a unique user record based on the custom machine learning model. The custom machine learning model is generated based on a dataset and a dataset schema, which each or both may be unique to the user. As such, the custom machine learning model may also be unique to the user. The operator device 104 is permitted to access the server 102's machine learning models, datasets, and dataset schemas. The user devices 106 may be permitted to upload datasets and dataset schemas and/or to request classification of a record. Although the following description will be discussed with respect to the user devices request the classification of a record, a person of ordinary skill in the art would readily understand that the operator device 104 can also request classification of a record.

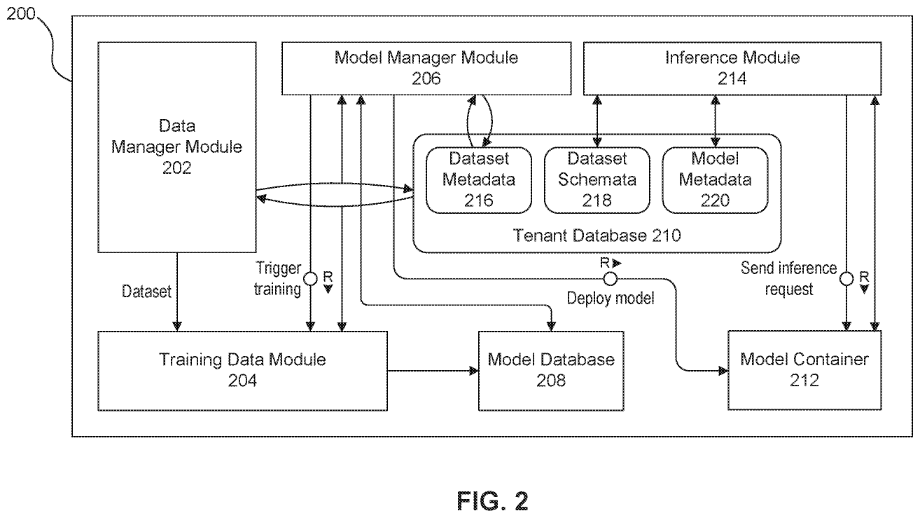

FIG. 2 is an example server 200 for generating a custom machine learning model to classify a unique user data record, as explained above with respect to server 102 of FIG. 1. The server 200 may be deployed and/or provided on a cloud computing environment or at a user site. In turn, the server 200 may be accessed by the operator device 104 and the user devices 106 (of FIG. 1) via the cloud computing environment. The server 200 may include a data manager module 202, a training data module 204, a model manager module 206, a model database 208, a tenant database 210, a model container 212 and/or an inference module 214. In accordance with an embodiment, these components may communicate with each other using a JSON format, although one skilled in the relevant arts will appreciate that any data interchange format may be used.

The data manager module 202 may receive a selection of a dataset and/or dataset schema from a user. As such, the data manager module 202 may permit the user to upload user unique datasets and/or dataset schemas via a comma-separated values file (CSV) file, which may be compressed. As such, each line of the CSV file may comprise a record, which may have one or more fields.

As stated above, the dataset may be unique to a user. As such, the dataset may relate to a category of products (e.g., electronics, shoes, furniture) and include sample products within the category having specified attributes. Table 1 provides an example dataset. In Table 1, the dataset relates to electronic products and provides two sample electronic products having five specified attributes (e.g., manufacturer, description, price, product category, and product subcategory).

TABLE 1

| Manufacturer | Description | Price | Category | Subcategory |
|---|---|---|---|---|
| ABC | Edit and | 59.99 | Computers | Software |
| | share your | | | |
| | documents | | | |
| XYZ | Digital camera | 490.00 | Cameras | DSLR |
| | (24MP, 3 in | | | |
| | LCD display) | | | |

Moreover, the dataset schema may include a description of a structure of a dataset. As such, the dataset schema's description may specify the characteristics (e.g., fields) required by the dataset. The characteristics may include specific attributes of the product (e.g., manufacturer, description, price, product category, and product subcategory), an expected input for the attribute type of the product (e.g., category, text, or number), and/or an indication of whether the attributes is a feature or a label. Although features and labels are both characteristics of the product, features may be inputs in the model and labels may be outputs of the model. Table 2 provide an example dataset schema for the dataset provided in Table 1.

TABLE 2

| Attribute Name | Attribute Type | Feature or Label |
|---|---|---|
| Manufacturer | Category | Feature |
| Description | Text | Feature |
| Price | Number | Feature |
| Category | Category | Label |
| Subcategory | Category | Label |

As such, although the same datasets schemas may be used with different datasets, the dataset structure of the dataset schema may require certain fields. Thus, if the certain fields required by the dataset schema do not exactly match the dataset, the dataset is marked as invalid and an error message is reported to the user. And since the dataset and dataset schema may be uploaded by the user, the datasets and/or dataset schemas may be unique to a particular user.

Moreover, the data manager module 202 may be in communication with the tenant database 210 to provide pre-stored datasets and/or dataset schemas. For example, available datasets and dataset schemas may be stored in the dataset metadata database 216 and dataset schema database 218 of the tenant database 210, respectively. The pre-stored datasets or dataset schemas may be generic or unique. For instance, the unique datasets and/or dataset schemas may have been previously uploaded by the user. Alternatively, the generic dataset and/or dataset schemas may be provided by the system operator device 106 (of FIG. 1). And the generic datasets/dataset schemas may be used with different users and/or records. The generic dataset/dataset schemas may account for existing users classify such records.

Upon selection of a particular dataset and dataset schema, the data manager module 202 may determine if the dataset is valid. The validity may depend on the dataset having more than a predetermined number of records (e.g., 100). The validity may also depend on the dataset containing the appropriate fields per the dataset schema. As stated above, the dataset schema indicates the number and type of fields expected in the dataset. If the dataset has a different number and/or type fields, the dataset may not be valid. After validation of the dataset, the data manager module 202 may provide the dataset and/or dataset schema to the tenant database 210 for storage or, as will be discussed in more detail below, to the training data module 204 for training a machine learning model.

The model manager module 206 may manage machine learning models throughout their implementation process. As such, the model manager module 206 may manage machine learning models that are trained or untrained, as well as those that are deployed or undeployed. To do so, the model manager module 206 may present machine learning models and/or model templates to the user. As such, the model manager module 206 may permit selection of a particular machine learning model or a particular model template.

The presented machine learning models may be deployed (e.g., available for selection by a user and ready to classify product) such that inference requests can be sent thereto or undeployed (e.g., unavailable for selection by a user and not ready to classify product) such that inference requests may not be sent thereto. As stated above, the deployed machine learning models may be used for predicting a classification of a record. Moreover, the model templates may define properties of a generic machine learning algorithm that is trained to learn patterns from a particular dataset selected by the user.

Along these lines, the model manager module 206 may be in communication with the training data module 204, the tenant database 210, and the model container 212. The training data module 204 may store the model templates and train a machine learning model based on the selected model template and dataset. The tenant database 210 may include a dataset metadata database 216 for storing metadata of datasets, a dataset schema database 218 for storing dataset schemata, and a model metadata database 220 for storing metadata of other trained machine learning models so that, for example, the user may compare the accuracy of different machine learning models training on the same dataset. The model container 212 may store custom machine learning models.

Upon a request from a user, the model manager module 206 may receive model templates from the training data module 204 and/or machine learning models from model database 208. As such, multiple model templates may be utilized with a particular dataset of the user. Along these lines, model templates may target particular groups of records (e.g., fruits, shoes, clothes, insurance, electronics, furniture). Alternatively, the model templates may be generic and thus be applicable to different users and/or records. Moreover, the machine learning models may be previously trained by the training data module 204, as will be discussed in more detail below, or provided to the model database 208 by the system operator device 106 (of FIG. 1). As such, the model manager module 206 may provide a list of available machine learning models and/or model templates for users to select.

Thus, the model templates contain a specification of a model learning algorithm that learns patterns from the datasets. As such, each model template presented to the user may be based on different machine learning algorithms that are configured to learn differently from the underlying dataset and dataset schema. Accordingly, a user may be presented with a particular type of machine learning algorithm (or a machine learning model) being utilized with a particular model template based on a name of the model template or an associated description of the model template. And the machine learning algorithms being utilized may those known to a person of ordinary skill in the art, such as those described in Bishop, Christopher M. Pattern Recognition and Machine Learning, Springer, 2006 and Goodfellow, Ian, Yoshua Bengio, and Aaron Courville. Deep learning, MIT press, 2016.

As such, the model templete specification may define the algorithmic steps that are to be taken in order to build a machine learning model from a given dataset schema. To do so, the model templetes also may specify different data/attribute types (e.g., numbers and text) are to be transformed into objects for the machine learning algorithm to process. For example, the model template may specify that a specific data preprocessing pipeline be utilized for textual fields and another data preprocessing pipeline be utilized for numerical values. And the model template may specify that the data/attribute types (e.g., numbers and text) be transformed into vectors in a vector space for the machine learning algorithm to process.

Accordingly, if the user would like to create a custom machine learning model, the user may select a particular model template. And the model manager module 206 may receive the request for the particular model template and then trigger the creation of the custom machine learning module via the training data module 204. However, if the user would like to classify a record using a previously trained machine learning model, the inference module 214 may receive the request to determine the classification of the record, as will be discussed in more detail below.

As stated above, the training data module 204 may receive a request from the model manager module 206 for training a machine learning model based on a selected model template. The training data module 204 may then also receive the dataset unique to the user from the data manager module 202. The training data module 204 may then train a generic machine learning model based on the unique dataset and the selected model template. The training data module 204 may train the generic machine learning model for a predetermined period of time (e.g., 30 seconds, 2 minutes, 5 minutes, etc.) and/or a predetermined number of iterations (e.g., 10, 50, 100, etc.).

After creating the custom machine learning model, the training data module 204 may provide the custom machine learning model to the model manager module 206. As such, the model manager module 206 may then present the custom machine learning model to users. The training data module 204 may also store the custom machine learning model in the model database 208.

The model manager module 206 may manage the custom machine learning model. As such, the model manager module 206 may be used to train, deploy, undeploy, and delete custom machine learning models that a user created. Similarly, the model manager module 206 may permit to validate and deploy previously created custom machine learning models. In doing so, the quality assessment of the custom machine learning models may be left to the user. The model manager module 206 may provide metrics related to the custom machine learning models to the user (e.g., accuracy precision, recall, F1-score). By doing so, the model manager module 206 may permit the user to compare metrics of different custom machine learning models to determine which is the most accurate and to determine which to deploy, undeploy or delete.

The inference module 214 may determine the classification of records based on machine learning models stored in the model container 212. As such, the inference module 214 may receive a request from the user for classification of a record. The request may indicate a particular custom machine learning model. The inference module 214 then forwards the request to the model container 212 to process. The model container 214 may then determine the appropriate classification for the record based on the custom machine learning model and return the classification to the inference module 214. The inference module 214 may then present the classification of the record to the user.

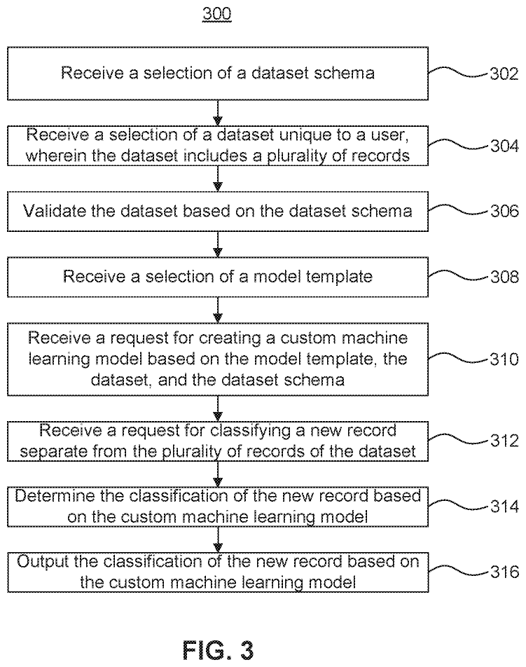

FIG. 3 is a flowchart for a method 300 for providing classification for a record, according to an embodiment. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIG. 2. However, method 300 is not limited to that example embodiment.

In 302, the server 200 receives a selection of a dataset schema. The dataset schema may be unique to the user or generic to different users or records.

In 304, the server 200 receives a selection of a dataset unique to a user, wherein the dataset includes a plurality of records. In some embodiments, along with the dataset, the data manager module 202 module may also receive the selection of the dataset schema. Moreover, the data manager module 202 may receive the selection of the dataset. The dataset may be received via a CSV file.

In 306, the server 200 validates the dataset based on the dataset schema. In some embodiments, the data manager module 202 may validate the dataset. The dataset schema may require the dataset to have an exact number and type of features.

In 308, the server 200 receives a selection of a model template. In some embodiments, the model manager module 206 may receive the selection of the model template.

In 310, the server 200 receives a request for creating a custom machine learning model based on the model template, the dataset, and the dataset schema. In some embodiments, the model manager module 206 may receive the request. As such, the model manager module 206 may trigger the training data module 204 to train a generic machine learning model based on the model template and the dataset.

In 312, the server 200 receives a request for a classification of a new record separate from the plurality of records of the dataset. In some embodiments, the inference module 214 may receive the request and provide it to the model container 212, which stores the custom machine learning model.

In 314, the server 200 determines the classification of the new record based on the custom machine learning model.

In 316, the server 200 outputs the classification of the new record based on the custom machine learning model to the user. In some embodiments, the inference module 214 may receive the classification from the model container 212, which determines the classification based on the stored custom machine learning model, and provides it to the inference module 214 to provide to the user.

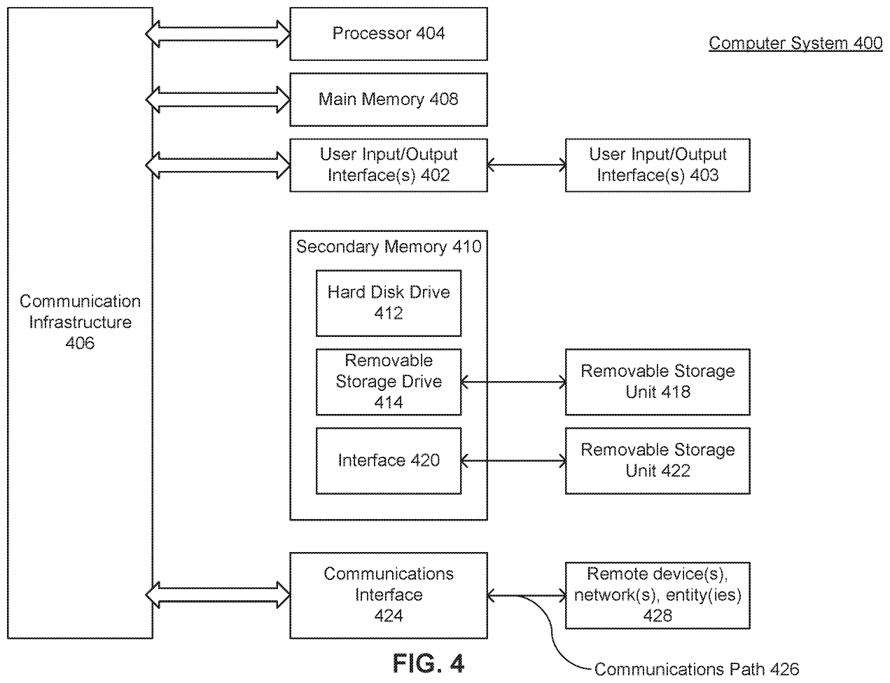

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure or bus 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content or container as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for classifying a new record, comprising:
receiving, by at least one processor, a dataset schema;
receiving, by the at least one processor, a dataset unique to a user, wherein the dataset includes a plurality of records separate from the new record;
validating, by the at least one processor, the dataset based on the dataset schema;
receiving, by the at least one processor, a selection of a model template;
receiving, by the at least one processor, a request for creating a custom machine learning model based on the model template, the dataset, and the dataset schema;
receiving, by the at least one processor, a request for a classification of the new record;
determining, by the at least one processor, the classification of the new record based on the custom machine learning model; and
outputting, by the at least one processor, the classification of the new record to the user.

2. The computer-implemented method of claim 1, wherein the dataset schema is unique to the user.

3. The computer-implemented method of claim 1, wherein the dataset and the dataset schema are uploaded by the user.

4. The computer-implemented method of claim 1, further comprising:
learning, by the at least one processor, one or more relationships between the plurality of records of the dataset,
wherein the custom machine learning model is created based on the learning of the one or more relationships.

5. The computer-implemented method of claim 4, wherein the model template is selected from a plurality of model templates.

6. The computer-implemented method of claim 5, wherein the plurality of model templates includes a first model template and a second model template different from the first model template, and wherein the selected model template is the first model template.

7. The computer-implemented method of claim 6, wherein the learning of the one or more relationships between the plurality of records for the first model template is based on a first generic machine learning algorithm, and wherein the learning of the one or more relationships between the records of the dataset for the second model template is based on a second generic machine learning algorithm.

8. The computer-implemented method of claim 1, wherein the dataset and the dataset schema are received by a data manager module, wherein the request for creating the custom machine learning model is received by a model manager module, and wherein the request for classifying the new record is received by an inference module.

9. The computer-implemented method of claim 7, further comprising:
triggering, by the at least one processor, a training data module to create the custom machine learning model,
wherein the triggering is performed by the model manager module.

10. The computer-implemented module of claim 8, wherein the custom machine learning model is stored in a model container.

11. The computer-implemented method of claim 9, wherein the inference module sends the request for classifying the new record to the model container to determine the classification based on the custom machine learning model.

12. A system, comprising:
a memory; and
at least one processor coupled to the memory and configured to:
receive a dataset schema,
receive a dataset unique to a user, wherein the dataset includes a plurality of records,
validate the dataset based on the dataset schema,
receive a selection of a model template,
receive a request for creating a custom machine learning model based on the model template, the dataset, and the dataset schema,
receive a request for a classification of a new record separate from the plurality of records,
determine the classification of the new record based on the custom machine learning model, and
output the classification of the new record to the user.

13. The system of claim 11, wherein the dataset schema is unique to the user.

14. The system of claim 12, wherein the dataset and the dataset schema are uploaded by the user.

15. The system of claim 11, wherein the custom machine learning model is created based on a generic machine learning algorithm configured to learn relationships between the plurality of records of the dataset.

16. The system of claim 11, wherein the dataset and the dataset schema are received by a data manager module, wherein the request for creating the custom machine learning model is received by a model manager module, and wherein the request for classifying the new record is received by an inference module.

17. The system of claim 16, wherein the model manager module is configured to trigger a training data module to create the custom machine learning model.

18. The system of claim 17, wherein the custom machine learning model is stored in a model container.

19. The system of claim 18, wherein the inference module sends the request for classifying the new record to the model container to determine the classification based on the custom machine learning model.

20. A non-transitory computer-readable device having instructions stored thereon that, when executed by at least one computing device, cause the at least one computing device to perform operations comprising:
receiving a dataset schema;
receiving a dataset unique to a user, wherein the dataset includes a plurality of records;
validating the dataset based on the dataset schema;
receiving a selection of a model template;
receiving a request for creating a custom machine learning model based on the model template, the dataset, and the dataset schema;
receiving a request for a classification of a new record separate from the plurality of records based on the custom machine learning model;
determining the classification of the new record based on the custom machine learning model; and
outputting the classification of the new record to the user.
